(19) United States
(12) Patent Application Publication
(10) Pub. No.: US 2016/0305609 A1
(43) Pub. Date: Oct. 20, 2016

(54) ADSORBENTS IN COMPRESSED GAS STORAGE SYSTEM

(71) Applicant: HECR, LLC, Fort Wayne, IN (US)

(72) Inventor: Stan A. Sanders, Fort Wayne, IN (US)

(21) Appl. No.: 15/062,837

(22) Filed: Mar. 7, 2016

Related U.S. Application Data
(60) Provisional application No. 62/148,833, filed on Apr. 17, 2015.

(51) Int. Cl. F17C 11/00; F17C 1/08

(52) U.S. Cl. CPC F17C 11/00; F17C 1/08; F17C 2209/232; F17C 2203/012; F17C 2203/0604; F17C 2203/0658; F17C 2209/21

(57) ABSTRACT

A method of forming a pressure vessel including adsorbent materials comprises forming a continuous liner defining a central bore, aligning a screw within the central bore; and distributing adsorbent materials within the central bore using the screw. A method of forming adsorbent materials for installation in a continuous pressure vessel comprises encasing a support structure within a permeable liner and distributing adsorbent materials between the support structure and the permeable liner. A method of forming an adsorbent framework for installation in a continuous pressure vessel comprises distributing adsorbent materials between corrugated sheets, coupling respective ends of the corrugated sheets to form an adsorbent layer, and rolling the adsorbent layer to form an adsorbent framework shaped for installation into the continuous pressure vessel.

### CROSS-REFERENCE TO RELATED APPLICATION(S)

This application claims priority to U.S. Provisional Patent Application Ser. No. 62/148,833, titled “Adsorbents in Compressed Gas Storage System,” filed Apr. 17, 2015, and incorporated herein by reference.

This application is a continuation in part of U.S. Utility patent application Ser. No. 14/532,116, titled “Compressed Gas Storage Systems” which claims the benefit of U.S. Provisional Patent Application Serial No. 61/908,350, titled “Oxygen Belt Breathing Pack,” filed Nov. 25, 2013, and U.S. Provisional Application Ser. No. 61/917,598, titled “Compressed Natural Gas Fuel Cell,” filed Dec. 18, 2013, and is a continuation in part of U.S. Utility patent application Ser. No. 14/081,779, titled “Integrated Dive Suit,” filed Dec. 4, 2013, which claims the benefit of U.S. Provisional Patent Application Ser. No. 61/733,282, titled “Integrated Dive Suit,” filed Dec. 4, 2012. The contents of the '116, '350, '598, '779, and '282 applications are incorporated herein by reference.

### BACKGROUND

Existing compressed gas pressure vessels inclusive of adsorbents are two-part vessels or vessels with mechanically-applied end treatments or sealing systems. These pressure vessels are prone to failure at seam locations or locations of end treatments due to expansion stress from high pressure on the walls of the pressure vessels.

### SUMMARY

Disclosed herein are methods of forming pressure vessels including adsorbent materials and for forming adsorbent materials for inclusion within pressure vessels.

One implementation is a method of forming a pressure vessel including adsorbent materials. The method includes forming a continuous liner defining a central bore, aligning a screw within the central bore, and distributing adsorbent materials within the central bore using the screw.

Another implementation is a method of forming adsorbent materials for installation in a continuous pressure vessel. The method includes encasing a support structure within a permeable liner. The support structure includes a support tube defining a central bore and spaced support disks disposed along the support tube and surrounding the central bore. While encasing the support structure within the permeable liner, the method further includes distributing adsorbent materials between the support structure and the permeable liner.

Another implementation is a method of forming an adsorbent framework for a continuous pressure vessel. The method includes distributing adsorbent materials between corrugated sheets. After distributing the adsorbent materials, the method includes coupling respective ends of the corrugated sheets to form an adsorbent layer. After forming the adsorbent layer, the method includes rolling the adsorbent layer to form an adsorbent framework shaped for installation into the continuous pressure vessel.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic of a production machine for forming a flexible, continuous pressure vessel with simultaneous inclusion of adsorbent materials.

FIGS. 2A & 2B are detailed views of a portion of FIG. 1, specifically, a drive head extruder.

FIGS. 3A & 3B are detailed views of a portion of the machine of FIG. 1, specifically, a pneumatic forming tool.

FIG. 4 is a detailed view of a portion of the machine of FIG. 1, specifically, the drive head extruder of FIGS. 2A & 2B and the pneumatic forming tool of FIGS. 3A & 3B.

FIGS. 5A & 5B are detailed views of a portion of the machine of FIG. 1, specifically, the drive head extruder of FIGS. 2A, 3B, and 4.

FIGS. 6A & 6B are detailed views of a portion of the machine of FIG. 1, specifically, a reformer section.

FIG. 7 is a detailed view of a portion of the machine of FIG. 1, specifically, a corrugator.

FIG. 8 is a detailed view of a portion of the machine of FIG. 1, specifically, a finishing corrugator.

FIG. 9 is a detailed view of a portion of the machine of FIG. 1, specifically, a reheating unit, braiding unit, and collection unit.

FIGS. 10A & 10B show side sectional views of a loose adsorbent loading machine.

FIG. 11A shows a side sectional view of a sock-style adsorbent for use in a continuous pressure vessel.

FIG. 11B shows a side sectional view of a solid adsorbent for use in a continuous pressure vessel.

FIGS. 12A-C show detail views of a support frame for the sock-style adsorbent of FIG. 11A.

FIG. 13 is a schematic of a production machine for forming a chain of the sock-style adsorbents of FIG. 11A.

FIG. 14 is a schematic of a production machine for forming a chain of the solid adsorbents of FIG. 11B.

FIGS. 15A-C show side and sectional views of solid adsorbent materials for use in a continuous pressure vessel.

FIG. 16 is a schematic of a realignment machine for use with a chain of continuous pressure vessels including adsorbent materials.

FIGS. 17A & 17B are a sectional view and a side cut-away view of one of the pressure vessels within the chain of continuous pressure vessels of FIG. 16.

FIGS. 18A & 18B are a schematic view and a detail view of the loose adsorbent loading machine of FIGS. 10A & 10B.

FIGS. 19A & 19B are a side view and a sectional view of a finishing treatment for a continuous, corrugated pressure vessel.

FIGS. 20A & 20B are a side sectional view and a top view of an adsorbent disk framework for use in a continuous pressure vessel.

FIGS. 21A-F show side, perspective, top, and sectional views of adsorbent frameworks for use in a continuous pressure vessel.

FIG. 22 shows a facility installation for the production machine of FIG. 1.

### DETAILED DESCRIPTION

A continuous, seamless, chain-style pressure vessel is disclosed inclusive of adsorbent materials. In some embodiments, the adsorbent materials, for example, loose, solid, disposed on a structure of framework, or captured in a permeable mesh-style sock, are installed during extrusion of the continuous pressure vessel. In other embodiments, the adsorbent materials are installed after formation of the chain-style continuous pressure vessel using a magnetically aligned screw to deposit the materials within the body of the pressure vessel.

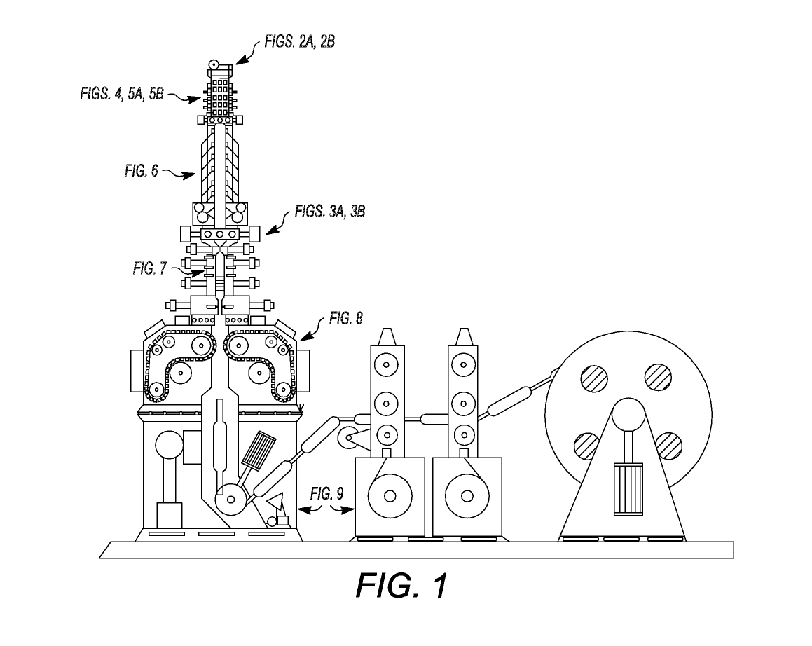

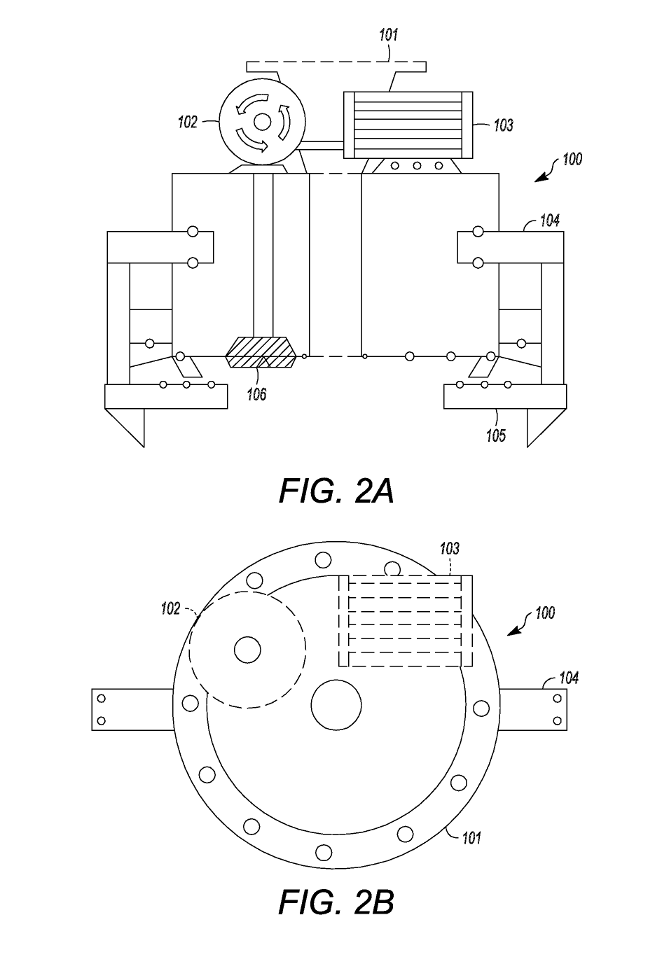

FIG. 1 is a schematic of a production machine for forming a flexible, continuous pressure vessel with simultaneous inclusion of adsorbent materials disposed on a pre-formed structure or framework. FIG. 1 includes references to various detailed views of the machine, specifically, references to FIGS. 2A, 2B, 3A, 3B, 4, 5A, 5B, 6, 7, 8, and 9. These figures are described in detail below.

FIGS. 2A &2B are detailed views of a portion of the production machine of FIG. 1, specifically, a side sectional view and a top view of a drive head extruder (100). The drive head extruder (100) includes a hole down the center for loading both material from a hopper (101) to form a continuous liner for the pressure vessel and prefabricated adsorbent cells to fill the interior of the continuous liner in a spaced fashion. The drive head extruder (100) rotates in order to maintain an even wall thickness of the pressure vessel during the extrusion process by keeping an even thermal temperature. The rotating head is anchored to the extruder main frame or barrel by external brackets using bearings for smooth rotation.

Rotation is achieved using a transfer reduction gear (102), a drive motor (103), a tracking bar and head mount (104), a rotation support bar (105), and an extruder drive gear (106). At this stage, the pressure vessel includes the continuous liner defining a central bore and has a single diameter set by the extrusion process. Changes in diameter along the pressure vessel are effected using the pneumatic forming tools described below.

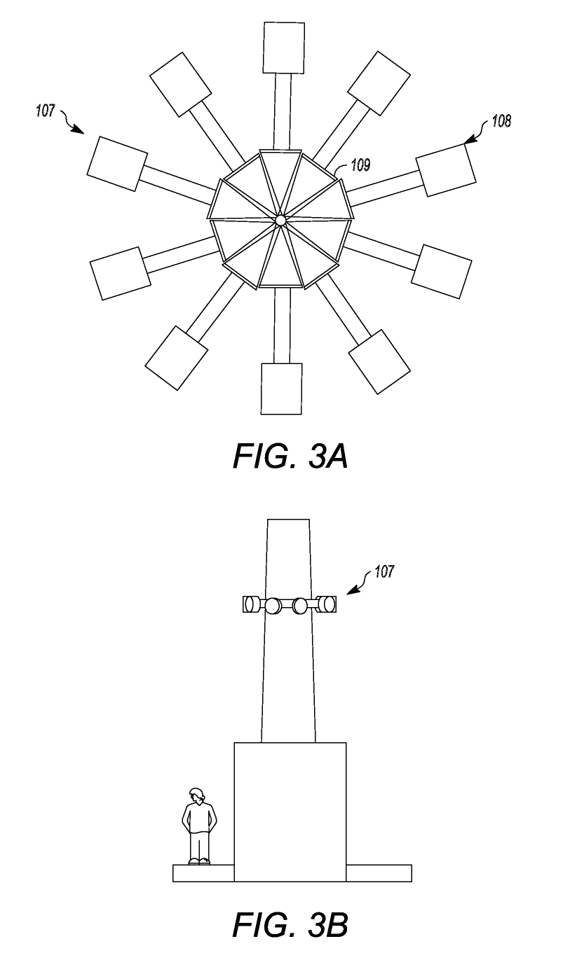

FIGS. 3A & 3B are detailed views of a portion of the production machine of FIG. 1, specifically a top view, FIG. 3A, and a side view, FIG. 3B, of a pneumatic forming tool (107). The pneumatic forming tool (107) is designed to control the shape and wall thickness of the continuous pressure vessel. The pneumatic forming tool (107) includes a variable hydraulic slide accumulator (108) inclusive of a slide plate formation core tool (109). The pneumatic forming tool (107) operates to reduce the diameter of the continuous pressure vessel at discrete locations, creating main sections of the pressure vessel of a first, larger diameter and intermediate sections of the pressure vessel of a second, smaller diameter.

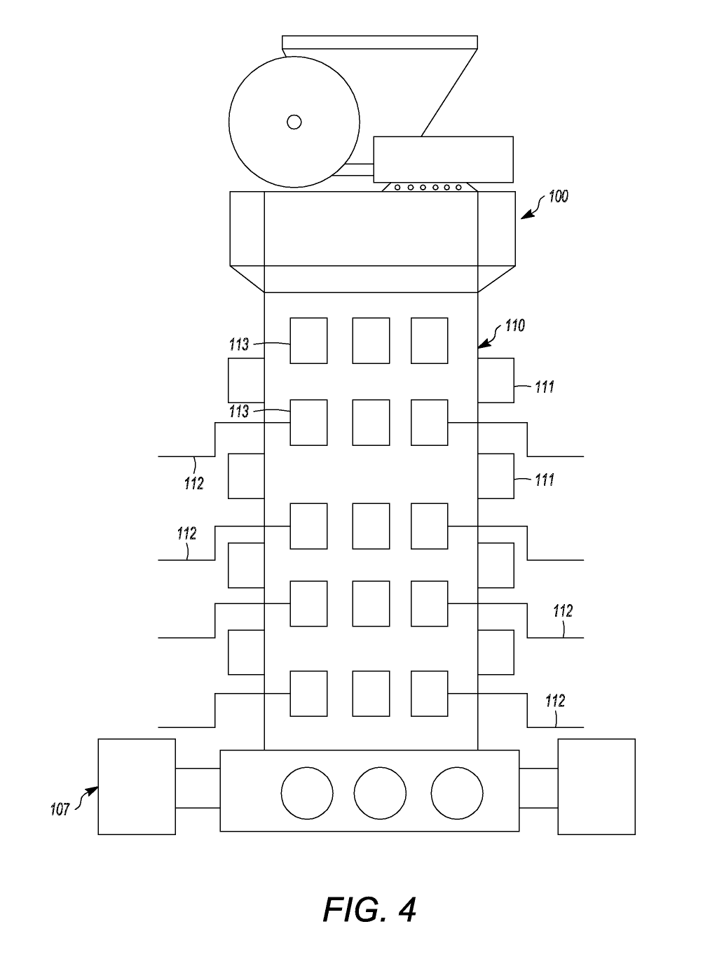

FIG. 4 is a detailed view of a portion of the production machine of FIG. 1, specifically, the drive head extruder (100) of FIGS. 2A & 2B and the pneumatic forming tool (107) of FIGS. 3A & 3B. The drive head extruder (100) is attached to a main frame casing (110) with heating units (111) disposed around the perimeter of the frame casing (110). The frame casing (110) also includes a plurality of air transfer lines (112) which include directional valves for positive and negative air pressure application during the extrusion process. The frame casing (110) also includes a plurality of magnets (113) configured to align a compounding screw within the frame casing (110). By keeping the compounding screw (not shown in this view) aligned, pre-formed adsorbent materials can more easily be loaded at the same time as formation of the continuous pressure vessel.

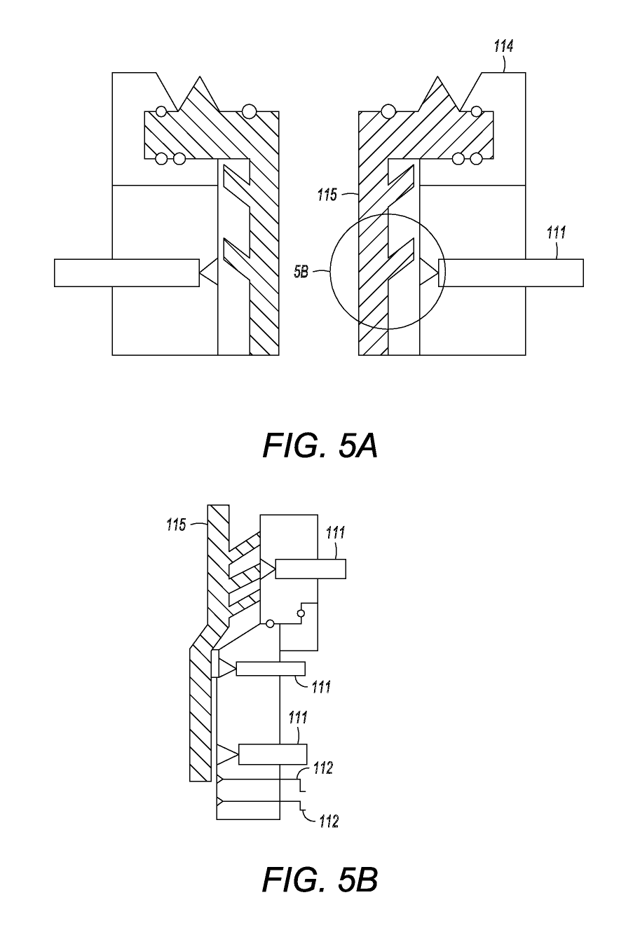

FIGS. 5A & 5B are detailed views of a portion of the production machine of FIG. 1, specifically, sectional views within the drive head extruder (100) of FIGS. 2A, 2B, and 4. A drive screw gear (114) is coupled to the extruder's self-supporting magnetic compounding screw (115). Heating units (111) are disposed adjacent to the magnetic compounding screw (115) to control the temperature of the pressure vessel material being extruded. Temperature control is also achieved using air transfer lines (112) for cooling. The drive head extruder (100) also includes a parison alignment guide or transfer block of non-metallic material. Again, the use of magnets (113) (not shown here) allows for alignment of the compounding screw (115) within the seamless, hollow extrusion for the continuous pressure vessel in order to more easily load the adsorbent materials.

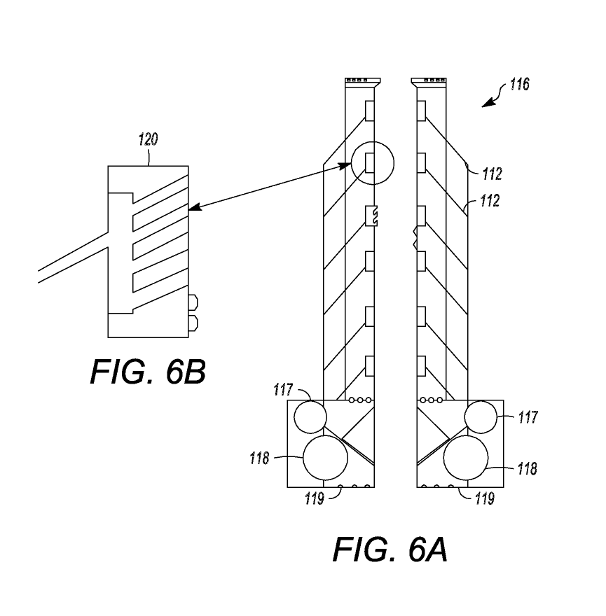

FIGS. 6A & 6B are detailed views of a portion of the production machine of FIG. 1, specifically, detailed views of a reformer section (116). The reformer section (116) includes a plurality of ultraviolet re-heaters (117) configured to maintain an even wall thickness of the pressure vessel during the extrusion process. Heated air stored within accumulators (118) can be forced into a cavity of the reformer section (116) via air transfer lines (112) to keep the walls of the continuous pressure vessel from sticking, sagging, knitting, separating, splitting, or otherwise deforming as the pressure vessel travels through the production machine. The reformer section (116) can also be rotated or translated along a pair of slide plates (119) as needed to avoid uneven wear. In the detail view of FIG. 6B, a stabilization core (120) is shown indicating air passages within the formation block of the reformer section (116) of the machine.

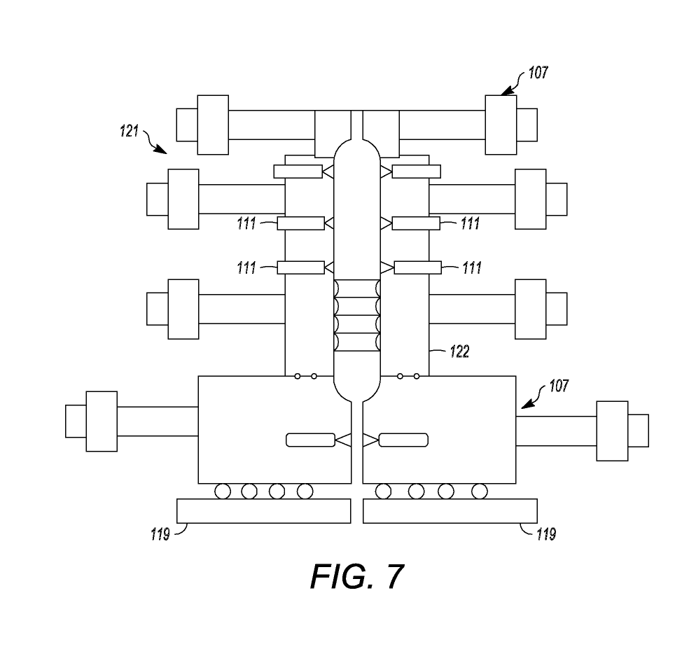

FIG. 7 is a detailed view of a portion of the production machine of FIG. 1, specifically, a corrugator (121). The corrugator (121) is disposed below another pneumatic forming tool (107) which is disposed at the bottom of the reformer section (116) shown in FIG. 6. Again, the pneumatic forming tool (107) allows for creation of the smaller diameter sections of the continuous pressure vessel. The corrugator (121) can form the external ribs on a continuous pressure vessel during the extrusion process. The corrugator (121) includes a support case (122) and heating units (111) configured to heat the extruded pressure vessel using pulse cycling. The corrugator (121) is also positioned above another variable hydraulic slide accumulator (107) and a pair of slide plates (119) which allow for rotation and translation of the support case (122) for maintenance purposes.

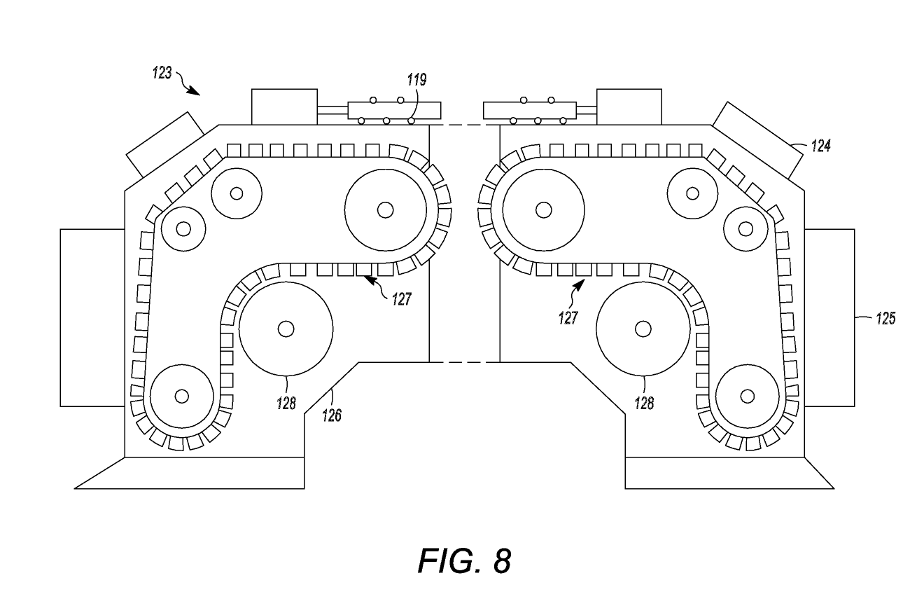

FIG. 8 is a detailed view of a portion of the production machine of FIG. 1, specifically, a finishing corrugator (123). The finishing corrugator (123) is disposed below the corrugator (121), variable hydraulic slide accumulator (107), and slide plates (119) of FIG. 7. The finishing corrugator (123) includes a pre-heater (124) supplying high-energy heated air as well as a cooling unit (125) supplying cooled air to control the temperature within the finishing corrugator (123). The finishing corrugator (123) include a main body (126) having two chains of transfer tool blocks (127) driven by drive units (128) each aligned on opposite sides of the main body (126). The transfer tool blocks (127), serving as shaping dies, are pressed against the outside surface of the continuous pressure vessel to give it the outside rib shape using a process of heated and cooled air.

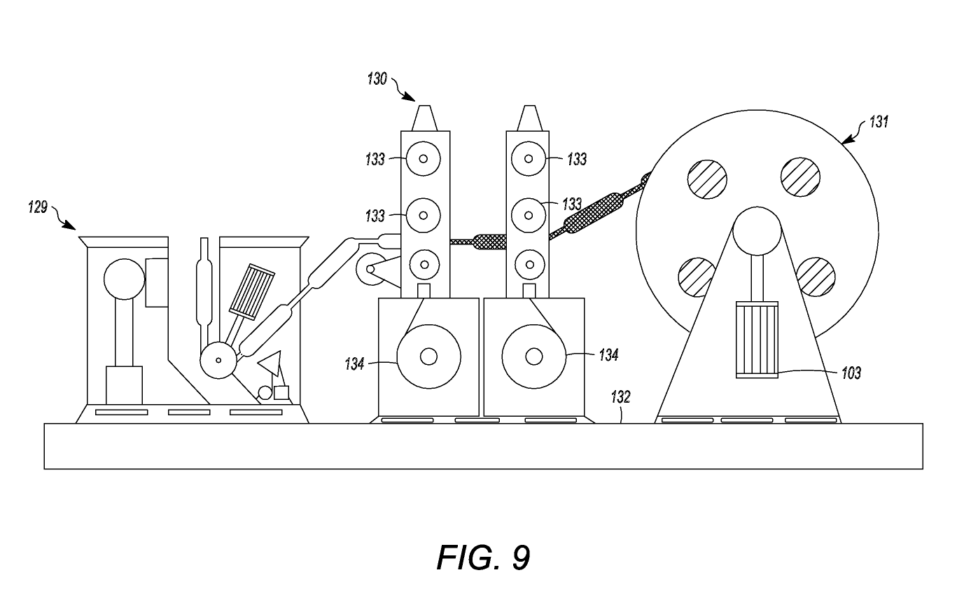

FIG. 9 is a detailed view of a portion of the production machine of FIG. 1, specifically, a reheating unit (129), a braiding unit (130), and a collection unit (131). These units (129, 130, 131) are situated on a support base (132) for the production machine of FIG. 1. The reheating unit (129) can apply heat to realign the plastic material of the continuous pressure vessel to close any gaps that may have formed in earlier steps of the process. The braiding unit (130) includes both overbraid material spools (133) and tri-axial material spools (134) with the tri-axial material being applied to the outside of the continuous pressure vessel before the overbraid material. After the various layers of outer material are applied, the continuous pressure vessel is collected on the collection unit (131) which employs a drive motor (103) to rotate the collection unit (131).

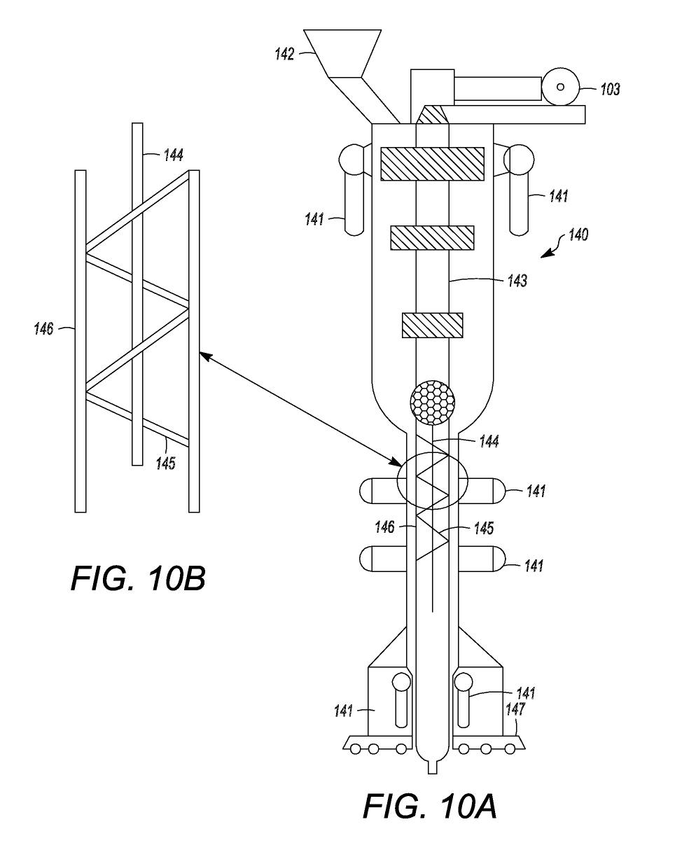

FIGS. 10A & 10B show side sectional views of a loose adsorbent loading machine (140). A hollow, continuous pressure vessel can be filled with loose adsorbent materials using variable sonic pulse vibrators (141) adjacent to an adsorbent hopper (142) in conjunction with a compounding screw (143) driven by a drive motor (103) and reduction gear (not shown). The loose adsorbent materials are fed from the hopper (142) and further distributed within the hollow core of the continuous pressure vessel by an adsorbent loading screw (144) that extends from the compounding screw (143) and is situated within a guide scene (145) as shown in the detail view of FIG. 10B. The adsorbent loading screw (144) and the guide scene (145) are located within a support shaft (146) and additional vibrators (141) within the loose adsorbent loading machine (140) ensure even distribution of the loose adsorbent materials. The adsorbent loading screw (144) can be serviced by means of a rotatable, translatable base plate (147) giving access to the adsorbent loading screw (144).

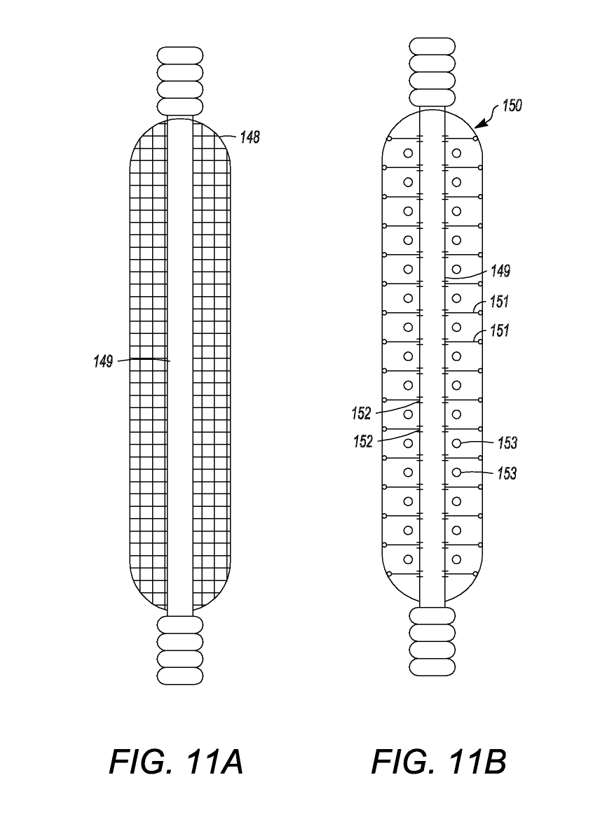

FIG. 11A shows a side sectional view of a permeable, sock-style adsorbent for use in a continuous pressure vessel. In this example, a permeable liner in the form of a mesh sock (148), for example, formed of nylon, is configured to contain adsorbent materials in a granular form. The mesh sock (148) surrounds a flexible hollow tube (149) which allows for the transfer of gas to the adsorbent materials within the mesh sock (148). The assembly of the mesh sock (148), hollow tube (149), and loose adsorbent material is shaped for installation within a hollow, continuous pressure vessel.

FIG. 11B shows a side sectional view of a solid adsorbent for use in a continuous pressure vessel. A pre-formed solid adsorbent (150) is disposed about the hollow tube (149) and includes flexible joints (151). The hollow tube (149) and the solid adsorbent (150) include holes (152) and passageways (153), respectively, for gas transfer. The solid adsorbent (150) can also be directly inserted into a hollow, continuous pressure vessel during a build process for the pressure vessel.

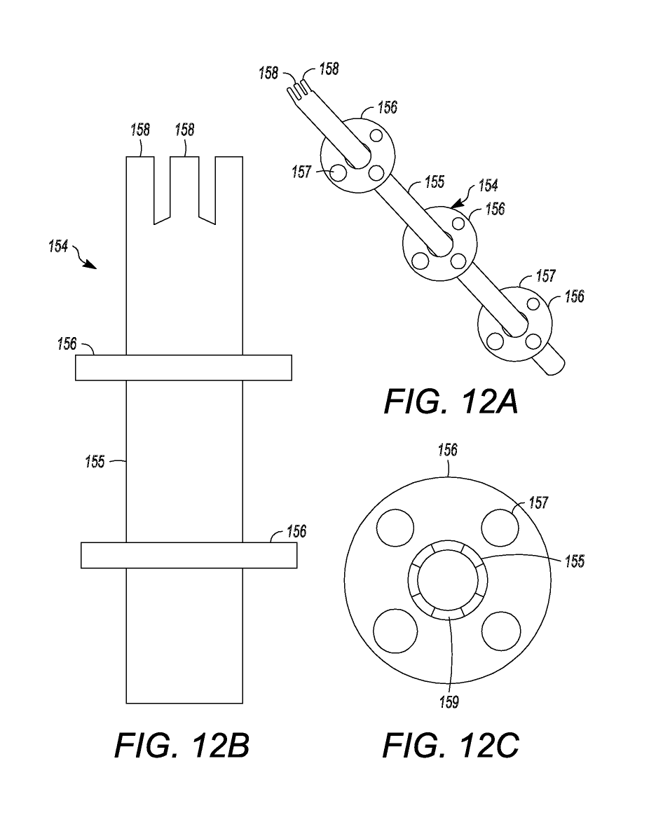

FIGS. 12A-C show detail views of a support frame (154) for the sock-style adsorbent of FIG. 11A. In FIG. 12A, a center support tube (155), similar in style to the hollow tube (149) of FIG. 11A, can be formed of material such as aluminum, plastic, etc. The support tube (155) can include support disks (156) configured to support the mesh sock (148) that holds the adsorbent materials of FIG. 11A and space the mesh sock (148) radially outward from the support tube (155). Both the support tube (155) and the support disks (156) can include passages or transfer holes (157, 159) for transfer of gases. In FIG. 12B, the support disks (156) are shown as located on the support tube (155) that extends to an end with locking fingers (158). The locking fingers (158) allow the support tube (155) to be anchored within the interior of the continuous pressure vessel. In FIG. 12C, a top view of a support disk (156) disposed on a support tube (155) is shown, with transfer holes (159) disposed within the support tube (155).

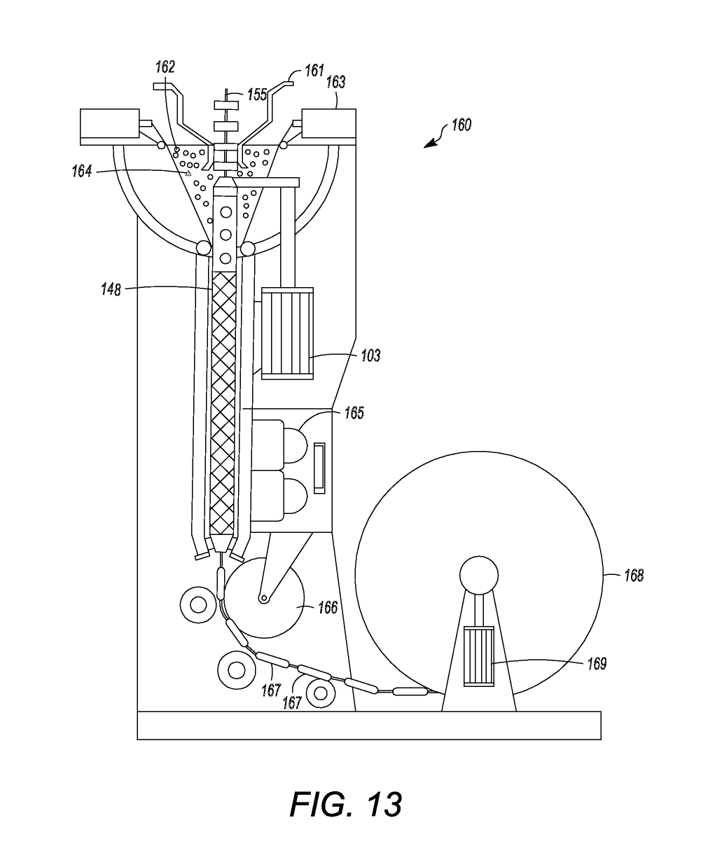

FIG. 13 is a schematic of another production machine (160) for forming a chain of the sock-style adsorbents of FIG. 11A. The support tube (155), shown here as truncated, is fed into the production machine (160) through the center of a loading hopper (161) at the same time that loose adsorbents (162) are fed into the hopper (161). A dispenser (163) simultaneously feeds the mesh sock (148) into the machine (160), thus capturing the adsorbents (162) between the support disks (156) and against the support tube (155) to form a sock adsorbent sleeve. In addition, a sensor (164) can be loaded between the mesh sock (148) and the support tube (155) along with the loose adsorbents (162). The sensor (164) can be designed to measure temperature, pressure, stress, strain, etc., allowing the user of the pressure vessel to determine operational characteristics at strategic locations within the vessel without the need for visual inspection.

The machine (160) also includes a drive motor (103), pulse vibrators (165), and a drive wheel (166) for moving the chain of adsorbent materials through the production process. The completed sock-style adsorbent cells (167), spaced along the sock adsorbent sleeve by intermediate regions where no adsorbents (162) are fed between the support tube (115) and the mesh sock (148), are driven onto a take-up reel (168) using a drive reel motor (169). The adsorbent cells (167) are then ready to be fed into a hollow, continuous pressure vessel during the extrusion process.

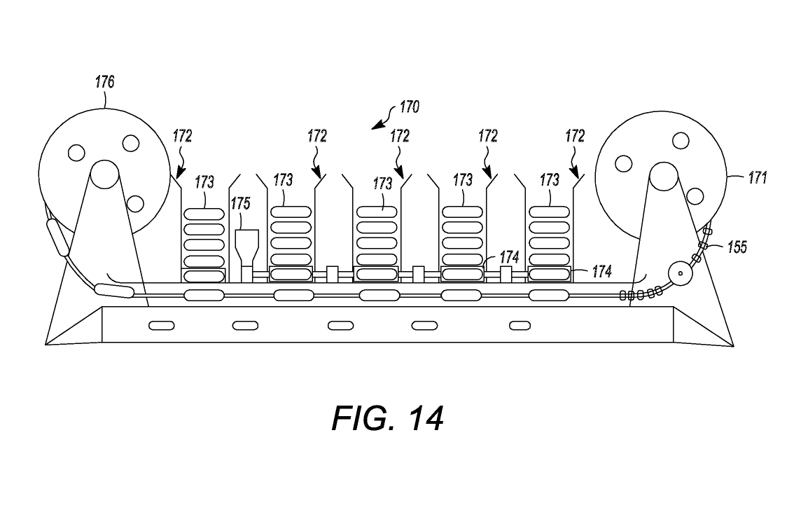

FIG. 14 is a schematic of another production machine (170) for forming a chain of the solid adsorbents of FIG. 11B. The support tube (155) is fed from a feed reel (171) beneath a series of loader guide mechanisms (172). Each loader guide mechanism (172) is filled with solid adsorbent pre-formed cartridges (173) which can be positioned within the loader guide mechanisms (172) and about the support tube (155) using a rotation guide tool (174) driven by a rotation guide tool motor (175). The machine (170) also includes a take-up reel (176) configured to collect completed solid adsorbent assemblies once the solid adsorbent cartridges (173) are loaded onto the support tubes (155).

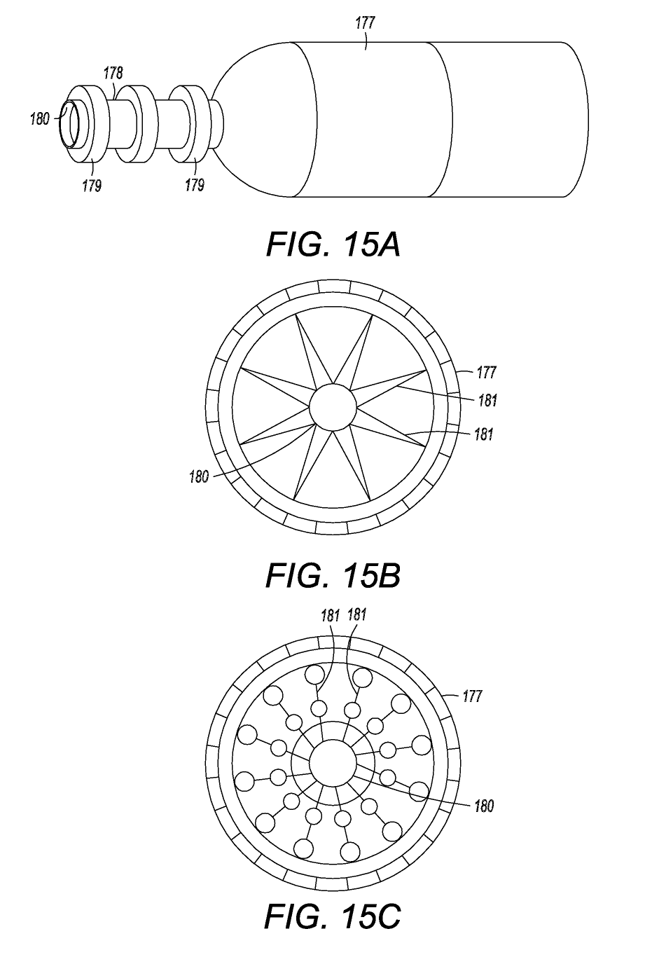

FIGS. 15A-C show side and sectional views of solid adsorbent materials for use in a continuous pressure vessel. In FIG. 15A, the outer shell (177) of a solid adsorbent is shown in combination with a flexible transfer tube (178) including corrugation rings (179). The outer shells (170) and connected transfer tubes (178) can be fit over a continuous, perforated inner tube (180). In FIG. 15B, a sectional view of the outer shell (177) and inner tube (180) also shows various gas transfer channels (181) allowing air to reach throughout the solid adsorbent. FIG. 15C is an alternative sectional view with a different, longitudinal style of gas transfer channels (181) running along the outside of the inner tube (180). The assembled solid adsorbent and inner tube (180) can be installed during production of a continuous pressure vessel as described previously.

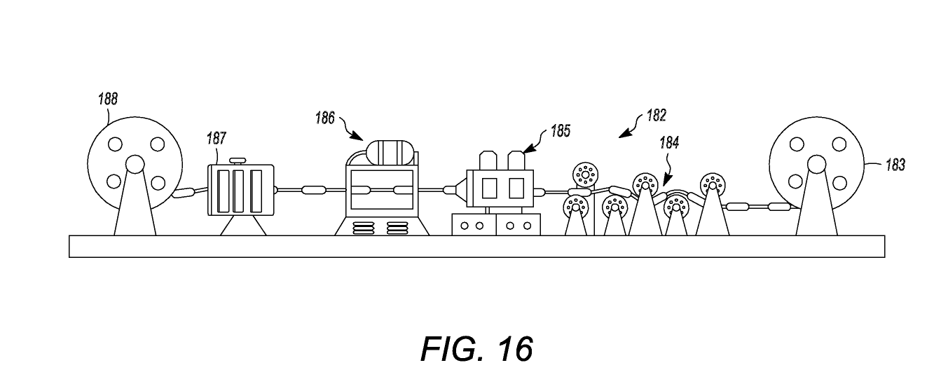

FIG. 16 is a schematic of a realignment machine (182) for use with a chain of continuous pressure vessels including adsorbent materials. This realignment machine (182) runs from right to left, with the chain of pressure vessels being provided by a dispensing spool (183). The chain of pressure vessels is guided through a realignment rolling mechanism (184) which ensures that straight pressurization of the final product is possible. After realignment, the chain of pressure vessels is fed into a film extruder (185) to apply an outer coating, where the outer coating can consist of various materials, such as Teflon or nylon. After the outer coating is applied, the chain of pressure vessels is fed through a liquid cooling tank (186) under vacuum pressure as supplied by a supply tank. After passing through the liquid cooling tank (186), the chain of pressure vessels is fed through a drying unit (187), for example, using air to dry the chain of pressure vessels. Finally, a variable-speed take-up reel (188) collects the re-aligned, coated, cooled, and dried chain of pressure vessels.

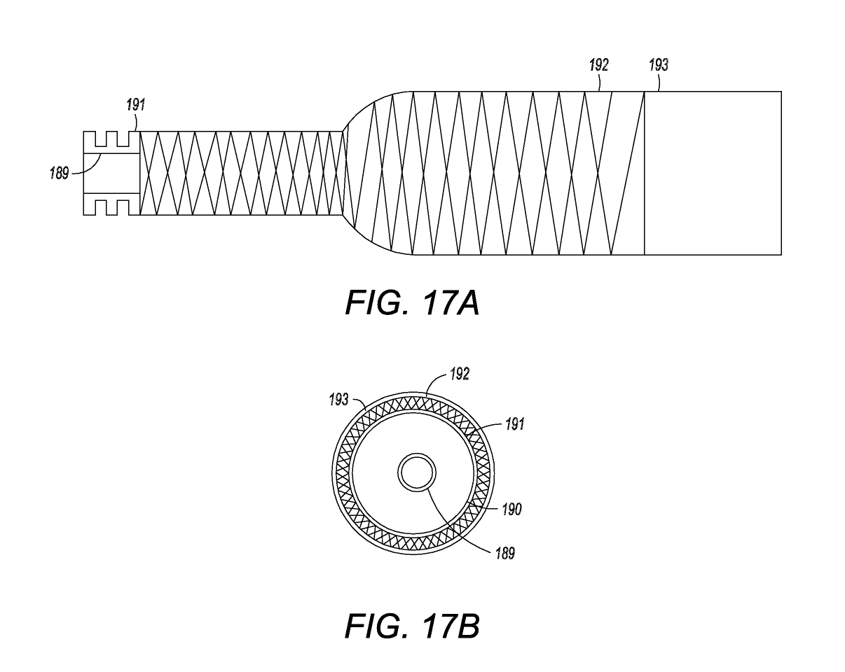

FIGS. 17A & 17B are a side cut-away view and a sectional view of one of the pressure vessels within the chain of continuous pressure vessels described in FIG. 16. The completed pressure vessel includes an inner air passageway or tube (189) surround by adsorbent material (190). The adsorbent material (190) is surrounded by a corrugated body (191) of the pressure vessel and further surrounded by an overbraid (192) and outer coating or shell (193) similar to that as described in FIG. 16.

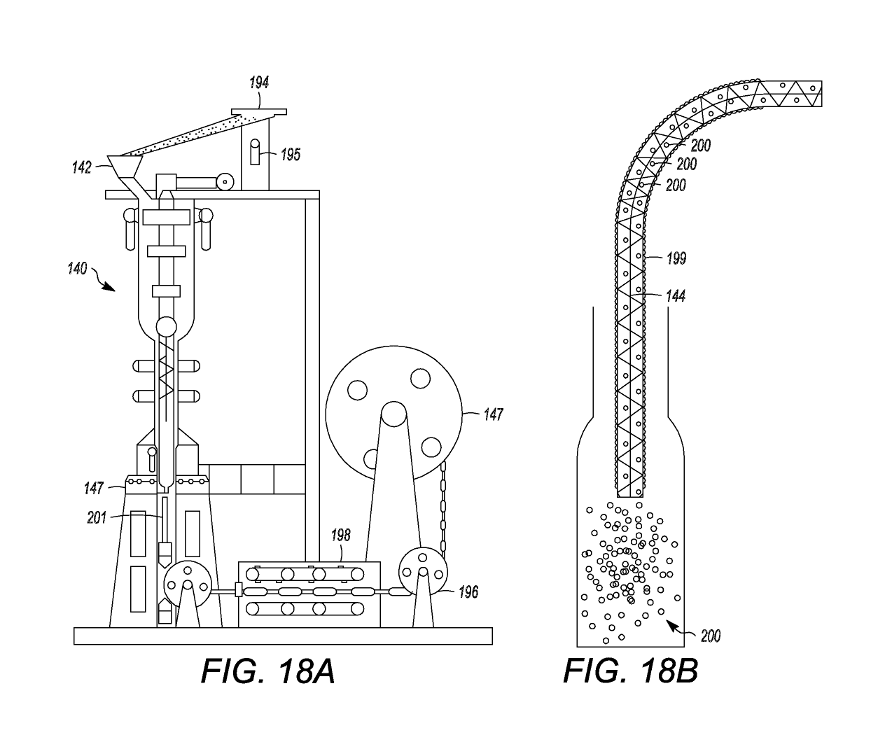

FIGS. 18A & 18B are a schematic view and a detail view of the loose adsorbent loading machine (140) of FIGS. 10A & 10B. In FIG. 18A, an adsorbent feed hopper (194) sends loose adsorbent into the main adsorbent hopper (142) according to speed and volume adjustment provided by a vibrator (195). The mechanics of the main body of the loose adsorbent loading machine (140) are as described in FIGS. 10A & 10B up to the location of the base plate (147). In order to fill a chain of hollow, continuous pressure vessels with adsorbents, a drive wheel (196) pulls the chain of continuous pressure vessels from a feed spool (197) into a bi-directional drive unit (198) where the chain of continuous pressure vessels is held in place.

As shown in the detail view of FIG. 18B, a hollow pressure vessel can receive a flexible feed tube (199) including the adsorbent loading screw (144) (see FIGS. 10A, 10B) in order for loose adsorbents (200) to be deposited in a metered fashion within the cavity of the pressure vessel. Once all vessels within the chain of continuous pressure vessels within the bi-directional drive unit (198) have been filled, the flexible feed tube (199) and adsorbent loading screw (144) are backed up toward the base plate (147).

Then, the bi-directional drive unit (198) can send the adsorbent-filled chain of continuous pressure vessels toward a cutting tool (201) inclusive of a drive piston and cutting blade attachment to remove the filled section. Next, the bi-directional drive unit (198) can re-position the next empty section of the chain of continuous pressure vessels such that the next empty section is ready to receive the flexible feed tube (199) and adsorbent loading screw (144). This process can be adapted for various chain lengths of pressure vessels or various lengths of the feed tube (199) and the adsorbent loading screw (144).

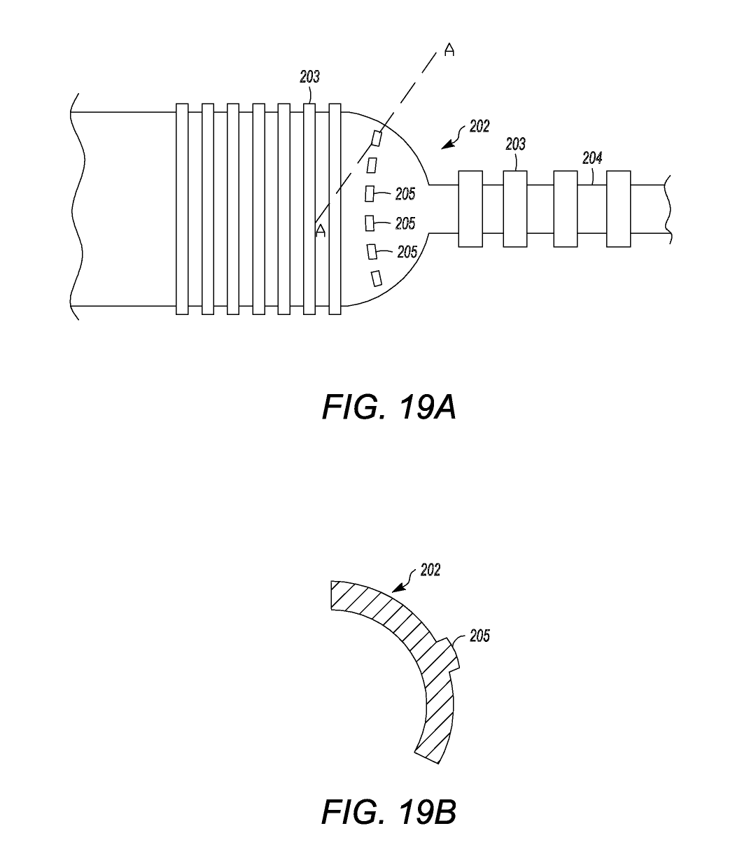

FIGS. 19A & 19B are a side view and a sectional view of a finishing treatment for a continuous, corrugated pressure vessel (202). In FIG. 19A, the example pressure vessel (202) is shown as including corrugation (203) on both the main body and the smaller diameter intermediate section or transfer tube (204). Along the transition between the main body and the transfer tube (204), a line of raised nubs (205) is formed onto the pressure vessel (202). These nubs (205) are configured to help align a layer of trans-axial fibers applied to the outer surface of the pressure vessel (202), that is, the nubs (205) act to minimize slipping of the trans-axial fibers. A cross-section cut through line A-A is shown in FIG. 19B detailing the shape of one of the raised nubs (205). Again, the raised nubs (205) are molded into the pressure vessel (202) in order to better support trans-axial fibers and avoid slipping during the braiding process. Further, the nubs (205) allow for more even spacing of the trans-axial fibers over the pressure vessel (202).

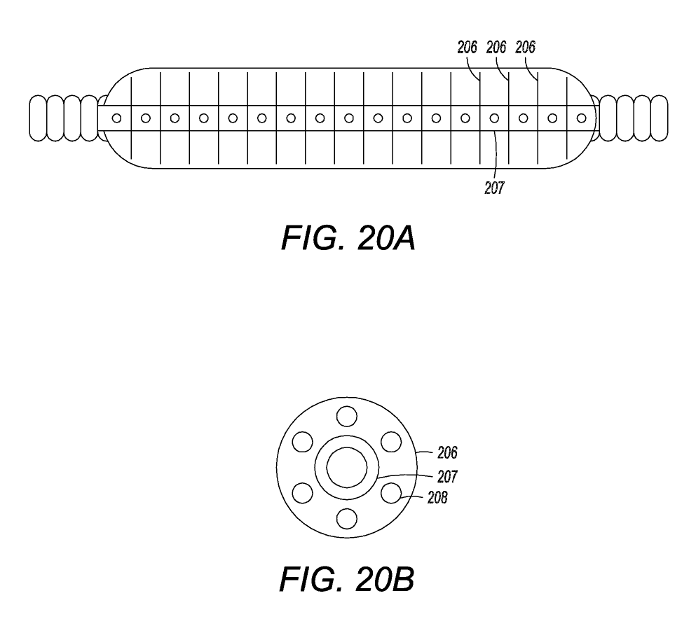

FIGS. 20A & 20B are a side sectional view and a top view of an adsorbent disk framework for use in a continuous pressure vessel. In FIG. 20A, multiple disks (206) are spaced along a perforated interior tube (207), and the surface of the disks (206) is used to adhere adsorbents later installed within the pressure vessel. In FIG. 20B, a pattern of openings (208) on a face of one of the disks (206) of FIG. 20A is shown, the openings (208) allowing gas to easily travel within the pressure vessel despite the presence of multiple, closely spaced disks (206) within the pressure vessel serving as the framework.

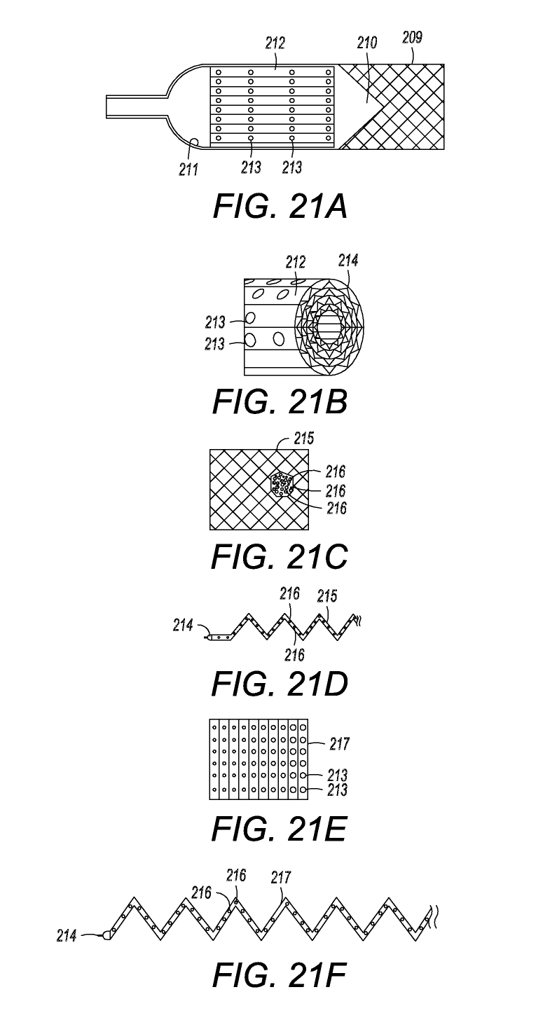

FIGS. 21A-D show side, perspective, top, and sectional views of adsorbent frameworks for use in a continuous pressure vessel. In FIG. 21A, a side cut-away view of a pressure vessel shows a braided reinforced fiber layer (209), a continuous core (210), for example, extruded and corrugated, and a hollow interior space (211) within the core (210) allowing for compressed gas accumulation. FIG. 21B shows an adsorbent layer formed from stacked corrugated sheets (212) that are rolled into a cylindrical shape to serve as an adsorbent framework providing multiple surfaces for adsorbent accumulation within the core (210) of the pressure vessel of FIG. 21A. The corrugated sheets (212) include a plurality of air flow passages (213) to maximize the gas transfer potential. Further, crimps (214) are provided on the corrugated edges of each corrugated sheet (212) to allow a flow space to be maintained between each of the corrugated sheets (212) within the overall adsorbent framework.

FIGS. 21C & 21D show a corrugated surface (215) in top and side views. The corrugated surface (215) is formed of mesh material configured for rolling and storage within a pressure vessel in the manner shown in FIG. 21B. The side view shows loose, particulate-style adsorbents (216) sandwiched between corrugated mesh layers and the top view shows a small cutaway view exposing the adsorbent (216). FIGS. 21E & 21F show a top and side view of a corrugated surface (217) including a plurality of air flow passages (213) such as those indicated in FIG. 21B. The side view also shows loose adsorbents (216) sandwiched between corrugated layers.

Both of the corrugated surfaces (215), (217) are formed using crimps (214) to seal internal adsorbents (216) and to maintain flow spaces between layers. Adsorbents can be applied in a coating on both inner and outer faces of the corrugated surfaces (215), (217) of the adsorbent framework (not shown) before rolling and insertion of the adsorbent framework into the pressure vessel. Alternatively, particulate-style adsorbents (216) can be trapped between corrugated surfaces (215), (217) of the adsorbent framework as shown in the side views of FIGS. 21D & 21F. By rolling spaced, corrugated sheets (212) to serve as adsorbent frameworks and installing these adsorbent frameworks into a pressure vessel, a maximum area for distribution of adsorbents (216) can be achieved while still allowing for maximum gas flow rate through the pressure vessel.

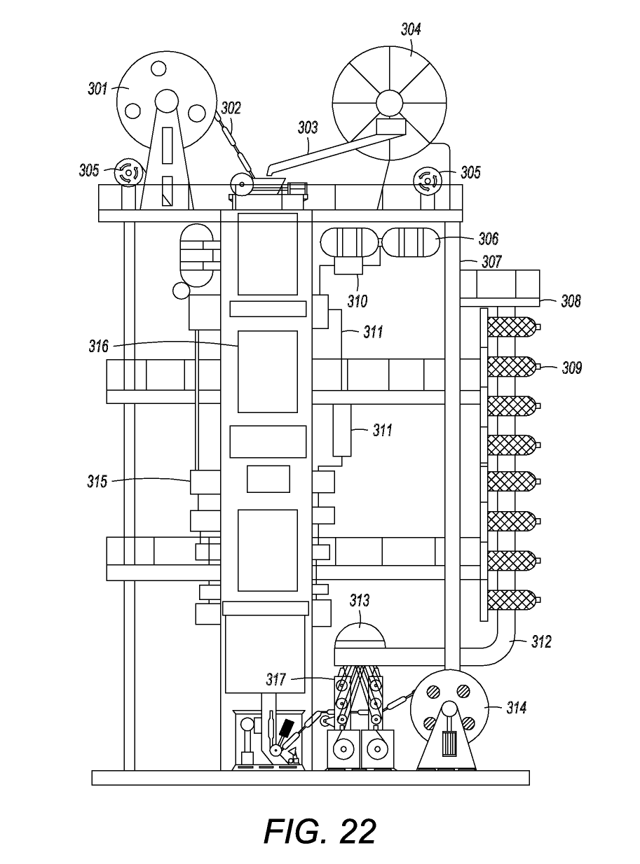

FIG. 22 shows a facility installation for the production machine of FIG. 1. Most of the production machine of FIG. 1 can be located within the tower (316) of the facility, though a take-up reel (314) and a braider (317) are shown outside of the tower (316). To feed the production machine, the facility installation includes both a core dispensing spool (301) to supply a continuous chain (302) of solid or sock-style pre-formed adsorbents and a polymer or plastic material loader (304) to supply pellets or powder using a supply shoot (303). Both the dispensing spool (301) and the plastic material loader (304) are driven by drive motors (305). To supply the pressurized air needed during use of the production machine, a series of vacuum pressure tanks (306), regulators (310), and air lines (311) can be disposed on the framework (307) of the facility installation near the tower (316). Also, the framework (307) can include one or more catwalks (308) with safety rails to allow workers to access various portions of the facility installation as needed for maintenance/loading of materials.

The braider (317) is supplied by a plurality of bobbin units (309) which send the reinforcing fibers applied to the outside of the adsorbent-filled chain of pressure vessels through a delivery tube (312). To avoid tangling the reinforcing fibers, a distribution head (313) is located at the end of the delivery tube (312). The distribution head (313) includes multiple openings to feed the reinforcing fibers from the bobbin units (309) to the application bobbins directly located on the braider (317). Finally, hydraulic units (315) are located outside of the tower (316) to supply the pneumatic forming tools of FIGS. 3A and 3B that control the shape and wall thickness of the continuous pressure vessel as it is formed over the adsorbent.

While this disclosure includes what is presently considered to be the most practical and preferred embodiments, it is to be understood that the disclosure is not to be limited to the disclosed embodiments but, on the contrary, is intended to cover various modifications and equivalent arrangements. For example, the processes defined above for installing adsorbents and/or adsorbent frameworks into continuous pressure vessels could also be employed to install other items, such as sensors, desiccants, filters, etc. into a chain of continuous, seamless pressure vessels.

What is claimed is:

1. A method of forming a pressure vessel including adsorbent materials, comprising:
forming a continuous liner defining a central bore;
aligning a screw within the central bore; and
distributing adsorbent materials within the central bore using the screw.

2. The method of claim 1, wherein forming the continuous liner includes extruding the continuous liner.

3. The method of claim 1, wherein forming the continuous liner includes forming a plurality of alternating main sections and intermediate sections wherein the main sections have a first diameter and the intermediate sections have a second diameter smaller than the first diameter.

4. The method of claim 1, further comprising:
corrugating the continuous liner, wherein corrugating the continuous liner includes heating the continuous liner and forming external ribs on the continuous liner.

5. The method of claim 1, wherein aligning the screw includes applying magnetic force to an exterior of the continuous liner and the screw.

6. The method of claim 1, wherein distributing the pre-formed adsorbent materials comprises:
supplying loose adsorbent materials from a hopper to the screw using vibration; and
rotating the screw to position the loose adsorbent materials along a length of the central bore.

7. The method of claim 1, wherein the screw extends along a guide scene within a support shaft, the guide scene and the support shaft being configured for even distribution of the adsorbent materials within the continuous liner.

8. A method of forming adsorbent materials for installation in a continuous pressure vessel, comprising:
encasing a support structure within a permeable liner, the support structure comprising:
a support tube defining a central bore; and
spaced support disks disposed along the support tube and surrounding the central bore; and
while encasing the support structure within the permeable liner, distributing adsorbent materials between the support structure and the permeable liner.

9. The method of claim 8, wherein an end of the support tube includes locking fingers configured to anchor the support tube within the continuous pressure vessel.

10. The method of claim 8, wherein the permeable liner comprises nylon or mesh.

11. The method of claim 8, wherein the support tube defines passages allowing transfer of fluid between the support tube and the permeable liner.

12. The method of claim 8, wherein the support disks define transfer holes allowing transfer of fluid between the support disks along the support tube and wherein the support disks are configured to space the permeable liner radially outward of the support tube.

13. The method of claim 8, wherein distributing the adsorbent materials includes intermittently feeding loose adsorbents between the support structure and the permeable liner using vibration to form spaced adsorbent cells.

14. The method of claim 13, wherein the spaced adsorbent cells are configured for installation within a continuous pressure vessel including alternating main sections and intermediate sections and wherein the main sections have a first diameter and the intermediate sections have a second diameter smaller than the first diameter.

15. A method of forming an adsorbent framework for a continuous pressure vessel, comprising:
distributing adsorbent materials between corrugated sheets;
after distributing the adsorbent materials, coupling respective ends of the corrugated sheets to form an adsorbent layer; and
after forming the adsorbent layer, rolling the adsorbent layer to form an adsorbent framework shaped for installation into the continuous pressure vessel.

16. The method of claim 15, wherein corrugated edges of each corrugated sheet include crimps to maintain spacing between the corrugated sheets within the adsorbent framework.

17. The method of claim 15, wherein the corrugated sheets comprise mesh.

18. The method of claim 15, wherein the corrugated sheets define passages allowing transfer of fluid between the corrugated sheets and the adsorbent materials.

19. The method of claim 15, further comprising:
distributing adsorbent materials on exterior surfaces of the corrugated sheets.

20. The method of claim 15, wherein the adsorbent framework is configured for installation within a continuous pressure vessel including alternating main sections and intermediate sections and wherein the main sections have a first diameter and the intermediate sections have a second diameter smaller than the first diameter.
